(19) United States
(12) Patent Application Publication
(10) Pub. No.: US 2021/0140096 A1
(43) Pub. Date: May 13, 2021

(54) GRAPHENE MATERIAL COATING AND PREPARATION METHOD THEREOF, AIR FILTRATION DEVICE AND SYSTEM

(71) Applicant: Linde ZHANG, Shenzhen (CN)

(72) Inventor: Linde ZHANG, Shenzhen (CN)

(21) Appl. No.: 16/316,048

(22) PCT Filed: Jun. 29, 2017
(86) PCT No.: PCT/CN2017/090723

§ 371 Date: Jan. 8, 2019

(30) Foreign Application Priority Data
Jul. 8, 2016 (CN) 201610538283.4

(51) Int. Cl. D06M 11/74; B01D 39/08; D06M 15/233; D06M 15/285; D06M 15/347; D06M 15/53; D06M 23/10

(52) U.S. Cl. CPC D06M 11/74; B01D 39/083; D06M 15/233; D06M 15/285; B01D 2201/31; D06M 15/53; D06M 23/10; B01D 2258/06; B01D 2201/0415; D06M 15/347

(57) ABSTRACT

A graphene material coating and a preparation method thereof pertain to the technical field of air filtration, and relates to an air filtration device and system based on the graphene material coating. The preparation method of the graphene material coating includes the following steps: S1), preparing a slurry dispersion stock solution: adding a dispersant and a binder to a solvent, and stirring to form the slurry dispersion stock solution; and S2), forming a graphene surface coating: adding a graphene powder to the slurry dispersion stock solution, and after being homogenized by stirring, coating a homogenate on a surface of a carrier, and drying to obtain a finished product of the graphene material coating. This technique can increase the adsorption rate of harmful substances in the gases and avoid secondary pollution caused by unstable adsorption.

### CROSS REFERENCE TO RELATED APPLICATIONS

This application is the national phase entry of International Application No. PCT/CN2017/090723, filed on Jun. 29, 2017, which is based upon and claims priority to Chinese Patent Application No. 201610538283.4 filed on Jul. 8, 2016, the entire contents of which are incorporated herein by reference.

### TECHNICAL FIELD

The present invention relates to the technical field of air filtration, in particular to a graphene material coating and a preparation method thereof, an air filtration device and system based on the graphene material coating.

### BACKGROUND

With industrialization of the human society, human's influence on nature has become increasingly significant, and air pollutants have gradually increased. The air pollutants can be roughly divided into two categories: aerosol air pollutants and gaseous air pollutants. Specifically, the chemical compositions of the aerosol air pollutants include various salts (e.g. cation: ammonium, potassium, sodium, magnesium, calcium, etc., and anion: sulfate, nitrate, chloride ion, organic acid radical, etc.), metal particles, sand and dust, inorganic carbon particles (e.g. black carbon, polymer carbon particles, etc.) and various organic compounds (e.g. VOCs droplets, PAHs, pollen, polymer particles, etc.), and sulfuric acid vapor etc. The gaseous air pollutants include the VOCs such as nitrogen oxides, sulfur oxides, carbon monoxide, lower alkanes, etc., as well as hydrogen halides, hydrogen sulfide, ammonia, and organic amine, etc.

At present, there are two commonly used air filtration techniques. One is to use a HEPA (High Efficiency Particulate Air) high-efficiency filter screen (made of polymer materials such as PP, etc., or inorganic materials such as glass fiber, etc.) which has a high removal rate for pollutant particles in the air. Such kind of filter screen can effectively remove particles with a size above 0.3 microns and the removal rate is up to 99.7%. The other one is to use activated carbon interlayered cloth or activated carbon coated cloth. The impure gases in the air are adsorbed on the activated carbon layer, thereby achieving the removal of gaseous pollutants.

However, the above-mentioned two commonly used air filtration techniques still have some defects. For example, none of these gas filtration materials can achieve an irreversible adsorption characteristic, thus a secondary pollution may always be caused and the effectiveness will be lost.

### SUMMARY

The technical problem to be solved by the present invention is to overcome the defects of the prior art, provide a graphene material coating and a preparation method thereof, and further provide an air filtration device and system based on the graphene material coating.

The present invention provides a graphene material coating. The graphene material is graphene and/or functionalized graphene. The graphene may be one or more items from a single-layer graphene, a few-layer graphene, and a multi-layer graphene (in detail, the few-layer graphene is a graphene having more than one layer but less than or equal to three layers, and the multi-layer graphene is a graphene having more than three layers but less than or equal to ten layers). The functionalized grapheme includes one or more items from aminated graphene, carboxylated graphene, cyanographene, nitrographene, borate-based graphene, phosphate-based graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride, and graphene iodide.

The graphene material coating provided by the present invention is based on the facts that the graphene material has an excellent surface chemical property, an affinity to free radicals, a n-n adsorption for a compound containing a benzene ring, etc. Most importantly, the graphene material itself has a remarkable adsorption capacity for polycyclic aromatic hydrocarbon compounds, and the absorption is very tight, so the absorbed polycyclic aromatic hydrocarbon compounds will not be eluted under the dissolution of various solvents. In the present invention, a proper solvent is selected, and the selected solvent is blended with a binder to uniformly coat on the surface of the filtration aiding layer and form a filter membrane, so that a uniform and stable filter membrane is formed on the surface of the filtration aiding layer. As a result, the harmful components (such as PAHs, PM2.5, PM10, nitrogen oxides, sulfur oxides, ozone, and other volatile/semi-volatile organic compounds, etc.) in the atmosphere can be blocked and absorbed on the coating formed by the graphene material while allowing the gas to flow stably, so that the filtered air is safe for breathing. Different functional groups are introduced into the graphene by means of functionalization, and some other pollutants such as heavy metals, sulfur oxides, nitrogen oxides, formaldehyde, xylene, etc. can further be removed more directionally. A dissociation of the adsorption of the different functional groups can be avoided by grafting the different functional groups, thereby improving the removal rate and avoiding the secondary pollution.

The present invention further provides a preparation method of a graphene material coating, which includes the following steps:

S1), preparing a slurry dispersion stock solution: adding a dispersant and a binder to a solvent, and stirring to form the sluy dispersion stock solution;

S2), forming a graphene material coating: adding a graphene material to the slurry dispersion stock solution, after being homogenized by stirring, coating a homogenate on a surface of a carrier, and drying to obtain a finished product of the graphene material coating.

In detail, in the S1):

the solvent includes one or more items from water, deionized water, ultrapure water, N-methylpyrrolidone, N,N-dimethylformamide, tetrahydrofuran, ethanol, n-pentane, ethyl acetate, butanone, heptane, benzene, toluene, 4-methyl-2-pentanone, isobutyl acetate, n-butyl acetate, m-xylene, n-butanol, 2-heptanone, n-hexane, ethylene glycol dimethyl ether, petroleum ether, ethylene glycol diethyl ether, chloroform, carbon tetrachloride, dichloromethane, dimethyl carbonate, ethyl methyl carbonate, diethyl carbonate, ethylene carbonate and isopropanol.

Preferably, the solvent is one or more items from deionized water, ethanol, ethyl acetate, methyl ethyl ketone, petroleum ether, diethyl carbonate and n-hexane.

Preferably, the solvent is subjected to a purification treatment.

Preferably, the purification treatment includes an organic solvent purification and an aqueous solvent purification. The organic solvent purification includes one or more steps of re-distillation, dehydration and drying. The aqueous solvent purification includes one or more items of re-distillation, deionization and reverse osmosis.

The dispersant includes one or more items from sodium polystyrene sulfonate, polystyrene sulfonic acid, polyvinyl pyrrolidone, sodium dodecyl sulfonate, sodium dodecyl benzene sulfonate, polyvinyl alcohol, sodium lignosulfonate, cetyltrimethylammonium bromide, sodium cholate, tetramethylammonium hydrogen carbonate, tetraethylammonium hydrogen carbonate, tetrabutylammonium hydrogen carbonate, dodecyl tetramethyl guanidine carbonate, cetyl tetramethyl guanidine carbonate and sodium cetyl benzene sulfonate.

Preferably, the dispersant is one or more items from sodium polystyrene sulfonate, polyvinyl pyrrolidone, sodium dodecyl benzenesulfonate, sodium dodecyl sulfonate and tetrabutylammonium hydrogen carbonate.

The binder includes one or more items from polyvinyl alcohol, polyethylene glycol, polyvinyl acetate emulsion, styrene-butadiene rubber emulsion, polyacrylic acid, polyacrylamide-polyacrylic acid emulsion, sodium polyacrylate, polytetrafluoroethylene, polyvinylidene fluoride, sodium alginate, sodium pectate, sodium antler, sodium carboxymethyl cellulose, dextrin, maltodextrin, epoxy resin, alkyd resin, amino resin, phenolic resin, polyurethane and organopolysiloxanes.

Preferably, the binder is one or more items from a polyvinyl acetate emulsion, sodium polyacrylate, sodium carboxymethyl cellulose, dextrin and epoxy resin.

A mass-to-volume ratio of the dispersant to the slurry dispersion stock solution is 0.1-5%.

A mass-to-volume ratio of the binder to the slurry dispersion stock solution is 5-40%.

In the step S2):

The graphene material is graphene and/or functionalized graphene. The graphene may be one or more items from a single-layer graphene, a few-layer graphene, and a multi-layer graphene (in detail, the few-layer graphene is a graphene having more than one layer but less than or equal to three layers, and the multi-layer graphene is a graphene having more than three layers but less than or equal to ten layers). The functionalized grapheme includes one or more items from aminated graphene, carboxylated graphene, cyanographene, nitrographene, borate-based graphene, phosphate-based graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride and graphene iodide.

Preferably, a finished product of graphene material coating has a coating thickness of 3-200 um.

The present invention further provides an air filtration device, which includes a filtering layer coated with the above-mentioned graphene material coating.

Preferably, the air filtration device further includes supporting layers. The supporting layers are located at two sides of the filtering layer.

Preferably, the constituent material of the supporting layer includes one or more items from polypropylene needle punched/spun-laced nonwoven fabric, polypropylene short staple filter cloth, polypropylene long staple filter cloth, polyterephthalate needle punched/spun-laced nonwoven fabric, polyester long staple filter cloth, polyester short staple filter cloth, pure cotton needle punched/spun-laced nonwoven fabric, pure cotton long staple filter cloth, pure cotton short staple filter cloth, polypropylene filter paper, glass fiber, cellulose filter paper, polypropylene-polyterephthalate composite filter paper, melt-blown polyester nonwoven fabric, melt-blown glass fiber, microporous ceramic filter plate, microporous polypropylene filter plate, cellulose acetate tow filter element, polypropylene tow filter element and cotton filter element.

Preferably, the air filtration device further includes an outer covering layer. The outer covering layer is located in an outer side of the supporting layer.

Preferably, the constituent material of the outer covering layer of the air filtration device includes one or more items from pure cotton gauze, pure cotton crepe cloth, pure cotton long staple filter cloth, pure cotton short staple filter cloth, polypropylene long staple filter cloth, polypropylene short staple filter cloth, polypropylene frame and polyethylene frame.

The present invention also provides an air filtration system, which includes the above-mentioned air filtration device.

The air filtration device and the air filtration system provided by the present invention are all provided with the above-mentioned graphene material coating. Therefore, the air filtration device and the air filtration system have corresponding technical effects, which are not repeated herein again.

### BRIEF DESCRIPTION OF THE DRAWINGS

In order to clarify the technical solutions of the embodiments of the present invention or the prior art, the drawings required for the embodiments or prior art are briefly described, hereinafter.

FIG. 1 is a profile structural diagram of the air filtration device of the present invention.

### DESCRIPTION OF THE REFERENCE DESIGNATORS

1—filtering layer; 2—supporting layer/filtration aiding layer; and 3—outer covering layer.

### DETAILED DESCRIPTION OF THE EMBODIMENTS

The present invention discloses a graphene material coating and a preparation method thereof, and further relates to an air filtration device and system based on the graphene material coating. Those skilled in the art can impelement the present invention through a proper adjustment for parameters of the processes with reference to the content of the present invention. In particular, it should be noted that all similar substitutions and modifications that are obvious to those skilled in the art should be considered as falling within the scope of present invention. The method and implementations of the present invention have been described through preferred embodiments, and it is obvious that the method and implementations described herein can be modified or appropriately changed and combined by the relevant personnel without departing from the content, spirit and scope of the present invention to implement and apply the techniques of the present invention.

Currently, the commonly used air filtration techniques still have some defects. Although the use of the HEPA high-efficiency filter screen can block particulate pollutants in aerogels, it is still powerless for the release of gaseous impurities adsorbed on the particulate pollutants. The HEPA high-efficiency filter screen attached with the particulate pollutants tends to become the secondary pollution source of the gas pollution. For example, a large amount of semi-volatile organic compounds such as PAHs, etc. and volatile organic compounds such as VOCs are usually adsorbed on the surface of particulate pollutants. When the particulate pollutants are intercepted, they are released from the particulate pollutants in a volatile manner and pass through the HEPA filter screen along with the fresh air. Similarly, for the technique that uses an activated carbon interlayered cloth or activated carbon coated cloth to achieve the air filtration, since the principle of physical adsorption is used for the filtration, there is a balance between the adsorption and the dissociation. After adsorbing VOCs, PAHs and other inorganic pollutant gases, the activated carbon coating will also become a secondary pollution source which continuously releases gases volatilized from the substances adsorbed thereon. Therefore, all the several gas filtration materials mentioned above can not realize a complete irreversible adsorption. As a result, a secondary pollution is often caused and the effectiveness is lost. For example, a large amount of semi-volatile organic compounds such as PAHs, etc. and volatile organic compounds such as VOCs are usually adsorbed on the surface of particulate pollutants. When the particulate pollutants are intercepted, they are released from the particulate pollutants in a volatile manner and pass through the HEPA filter screen along with the fresh air. Similarly, for the technique that uses an activated carbon interlayered cloth or activated carbon coated cloth to achieve the air filtration, since the principle of physical adsorption is used for the filtration, there is a balance between the adsorption and the dissociation. After adsorbing VOCs, PAHs and other inorganic pollutant gases, the activated carbon coating will also become a secondary pollution source which continuously releases gases volatilized from the substances adsorbed thereon. Therefore, all the several gas filtration materials mentioned above can not realize a complete irreversible adsorption. As a result, a secondary pollution is often caused and the effectiveness is lost.

First, the present invention provides a graphene material coating. The graphene material is graphene and/or functionalized graphene. The graphene may be one or more items from a single-layer graphene, a few-layer graphene and a multi-layer graphene (in detail, the few-layer graphene is a graphene having more than one layer but less than or equal to three layers, and the multi-layer graphene is a graphene having more than three layers but less than or equal to ten layers). The functionalized grapheme includes one or more items from aminated graphene, carboxylated graphene, sulfonated graphene, mercapto graphene, cyanographene, nitrographene, borate-based graphene, phosphate-based graphene, hydroxylated graphene, methylated graphene, allylated graphene, trifluoromethylated graphene, dodecylated graphene, octadecylated graphene, graphene oxide, graphene fluoride, graphene bromide, graphene chloride and graphene iodide.

Graphene material is a two-dimensional material with a large specific surface area. Therefore, the graphene material has good adsorption property. Taking graphene for example, the graphene can be considered as a carbon material composed of sp2 hybridized carbon atoms. In detail, each carbon atom of the graphene provides a Pz orbital which involves in the formation of a delocalized n bond on the surface of the grapheme with electrons. Thus, the surface of the whole graphene may be considered to be covered by the delocalized a bonds, and the surface of the PAHs also has a delocalized π bond system. Thereby, when the PAHs come in contact with the graphene, the π bonds of the two systems stack with each other, thus forming a x-n interaction force between the graphene and the PAHs. Since the n-n interaction force is strong, a large amount of PAHs are absorbed on the graphene material, and the absorption is firm. Different functionalized graphene can form chemical bonds (ion bonds, covalent bonds or secondary bonds) with some chemical species with specific structures because of different functional groups, so that such kind of chemical species with specific structures form chemical adsorptions. For example, the graphene has a strong adsorption capacity for PAHs, the graphene oxide has a strong adsorption capacity for formaldehyde, the carboxylated graphene is a grapheme modified by a weakly acidic group, so it has a strong adsorption capacity for alkaline substances (mainly including nitrogenous compounds such as ammonia, nitrogen dioxide, etc.), and the mercapto graphene has a strong adsorption capacity for heavy metals (such as lead, mercury, etc.). Thereby, the self-supporting graphene layer including the above-mentioned graphene material and the gas filtration device simultaneously have a better adsorption capacity for PAHs, formaldehyde, alkaline substances, and heavy metals in the air. Therefore, the above-mentioned graphene materials can adsorb other harmful components such as PM2.5, PM10, heavy metals, nitrogen oxides, sulfur oxides, ozone, other volatile/semi-volatile organic substances, etc. in the atmosphere without dissociation, thereby increasing the removal rate and avoiding secondary pollution. The present invention further provides a preparation method of a graphene material coating, which includes the following steps:

S1), preparing the slurry dispersion stock solution: adding a dispersant and a binder to a solvent, and stirring to form the slurry dispersion stock solution.

The solvent is an organic solvent and/or an aqueous solvent subjected to a purification treatment. The method for purifying the organic solvent includes one or more steps of re-distillation, dehydration and drying. The method for purifying the aqueous solvent includes one or more steps of re-distillation, deionization, and reverse osmosis. Preferably, the solvent includes one or more items of water, deionized water, ultrapure water, N-methylpyrrolidone, N,N-dimethylformamide, tetrahydrofuran, ethanol, n-pentane, ethyl acetate, butanone, heptane, benzene, toluene, 4-methyl-2-pentanone, isobutyl acetate, n-butyl acetate, m-xylene, n-butanol, 2-heptanone, n-hexane, ethylene glycol dimethyl ether, petroleum ether, ethylene glycol diethyl ether, chloroform, carbon tetrachloride, dichloromethane, dimethyl carbonate, ethyl methyl carbonate, diethyl carbonate, ethylene carbonate and isopropanol. The purified solvent can better dissolve the dispersant and the binder.

As a preferred embodiment of the present invention, the purified solvent preferably includes one or more items from deionized water, ethanol, ethyl acetate, methyl ethyl ketone, petroleum ether, diethyl carbonate and n-hexane, which can better dissolve the dispersant and the binder.

Preferably, the dispersant includes one or more items from sodium polystyrene sulfonate, polystyrene sulfonic acid, polyvinyl pyrrolidone, sodium dodecyl sulfonate, sodium dodecyl benzene sulfonate, polyvinyl alcohol, sodium lignosulfonate, cetyltrimethylammonium bromide, sodium cholate, tetramethylammonium hydrogen carbonate, tetraethylammonium hydrogen carbonate, tetrabutylammonium hydrogen carbonate, dodecyl tetramethyl guanidine carbonate, cetyl tetramethyl guanidine carbonate and sodium cetylbenzene sulfonate.

As a preferred embodiment of the present invention, the dispersant preferably includes one or more items from sodium polystyrene sulfonate, polyvinyl pyrrolidone, sodium dodecylbenzenesulfonate, sodium dodecylsulfonate and tetrabutylammonium hydrogen carbonate.

Preferably, when the mass-to-volume ratio of the dispersant to the slurry dispersion stock solution is 0.1-5%, the dispersion effect is better.

Preferably, the binder preferably includes one or more items from polyvinyl alcohol, polyethylene glycol, polyvinyl acetate emulsion, styrene-butadiene rubber emulsion, polyacrylic acid, polyacrylamide-polyacrylic acid emulsion, sodium polyacrylate, polytetrafluoroethylene, polyvinylidene fluoride, sodium alginate, sodium pectate, sodium antler, sodium carboxymethyl cellulose, dextrin, maltodextrin, epoxy resin, alkyd resin, amino resin, phenolic resin, polyurethane and organopolysiloxanes.

As a preferred embodiment of the present invention, the binder preferably includes one or more items from a polyvinyl acetate emulsion, sodium polyacrylate, sodium carboxymethyl cellulose, dextrin and epoxy resin.

Further, when the mass-to-volume ratio of the binder to the dispersion stock solution is 5-40%, the binding effect is better.

Further, the slurry dispersion stock solution is stirred at a rotation speed of 30-200 rpm for 1-2 h, and after being subjected to a vacuum defoamation treatment, the dispersion of the slurry is more uniform, so as to get ready for subsequent operations.

S2), forming a graphene material coating: adding a graphene material to the slurry dispersion stock solution in the S1), and after being homogenized by stirring, coating a homogenate on a surface of a carrier, and drying to obtain a finished product of the graphene material coating.

Preferably, the graphene material is graphene and/or functionalized graphene. The graphene may be one or more items from a single-layer graphene, a few-layer graphene, and a multi-layer graphene (in detail, the few-layer graphene is a graphene having more than one layer but less than or equal to three layers, and the multi-layer graphene is a graphene having more than three layers but less than or equal to ten layers). The functionalized grapheme includes one or more items from aminated graphene, carboxylated graphene, cyanographene, nitrographene, borate-based graphene, phosphate-based graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride and graphene iodide.

As a preferred technical solution of the present invention, the graphene material is added to the slurry dispersion stock solution in the step S1) one or more times, and stirred at a rotation speed of 30-8000 rpm for 20 min-8 h to form a graphene material homogenate.

Further, the rotation speed during the stirring is set as 30-200 rpm when the graphene material is added, so that the graphene material is sufficiently mixed with the dispersion slurry stock solution.

Further, the rotation speed during the stirring is set as 3000-8000 rpm after the graphene material is added, and the stirring time is 20-120 min; or the rotation speed during the stirring is set as 200 rpm after the graphene material is added, and the stirring time is 6-8 h.

As a preferred technical solution of the present invention, the graphene material homogenate is uniformly coated on the supporting layer by method of spraying coating, spin coating, blade coating or wetting.

As a preferred technical solution of the present invention, the supporting layer is dried by method of tunnel drying, hot air drying or vacuum drying, and the finished product of the graphene material is obtained as the weight is constant.

Further, the drying temperature is 60-120° C., and the drying time is 2-8 h.

Further, the coating thickness of a finished product of the graphene material coating is 3-200 um. With a thicker wet mold of the slurry, the graphene material will get shed during the subsequent drying process, while with a thinner coating thickness, the best effect for filtering the pollutants in the air cannot be achieved.

The present invention further provides an air filtration device on which a graphene material coating is used as a filtration material. Specifically, referring to FIG. 1, the FIGURE shows the structure of an air filtration device provided by an embodiment of the present invention. In a specific embodiment, the air filtration device includes a filtering layer coated with the graphene material coating, supporting layers and an outer covering layer. Further, the supporting layers are located on both sides of the graphene material coating to function as a filtration aiding layer, and the supporting layers are composed of a class of materials that have good air permeability, filterability and supportability. The outer covering layer is located in an outer side of the supporting layer to serve as a structure covered on the outermost layer, and the outer covering layer can make the filtering layer and the supporting layer being formed stably. The outer covering layer is mainly made of a material having a strong air permeability and structural strength. The supporting layer of the graphene material filtering layer is subjected to the processes of assembling, cutting, stitching, calendering, etc. with a suitable outer cladding material, then finally formed to make the air filtration device based on the graphene material coating.

As a preferred technical solution of the present invention, the constituent material of the supporting layer preferably includes one or more items from polypropylene needle punched/spun-laced nonwoven fabric, polypropylene short staple filter cloth, polypropylene long staple filter cloth, polyterephthalate needle punched/spun-laced nonwoven fabric, polyester long staple filter cloth, polyester short staple filter cloth, pure cotton needle punched/spun-laced nonwoven fabric, pure cotton long staple filter cloth, pure cotton short staple filter cloth, polypropylene filter paper, glass fiber, cellulose filter paper, polypropylene-polyethylene terephthalate composite filter paper, melt-blown polyester nonwoven fabric, melt-blown glass fiber, microporous ceramic filter plate, microporous polypropylene filter plate, cellulose acetate tow filter element, polypropylene tow filter element and cotton filter element.

As a preferred technical solution of the present invention, the constituent material of the outer covering layer of the air filtration device preferably includes one or more items from pure cotton gauze, pure cotton crepe cloth, pure cotton long staple filter cloth, pure cotton short staple filter cloth, polypropylene long staple filter cloth, polypropylene short staple filter cloth, polypropylene frame and polyethylene frame.

In addition, the air filtration device provided by the present invention can be expressed in different forms in different applications, such as a mask, a filtering layer of an air filtration device, etc.

In another specific embodiment, an air filtration system is further provided. The air filtration system includes the above-mentioned air filtration device.

Since the advantageous effects of the air filtration device in the embodiment corresponding to FIG. 1 have been described, the air filtration system configured with the above-mentioned air filtration device also has the corresponding technical effects, which will not be repeated herein.

The present invention will be further illustrated below in combination with some embodiments.

### Embodiment 1

A dispersant of polyvinylpyrrolidone and a binder of polyacrylamide-polyacrylic acid emulsion were respectively added to a deionized water to prepare a dispersion solution with the dispersant at a mass-to-volume ratio of 2% and the binder at a mass-to-volume ratio of 25%. After stirring at 100 rpm for 2 h, a homogeneous emulsion was formed and then subjected to a vacuum defoamation. Upon completion, the single-layer graphene powder was added to the dispersion solution in batches for several times. High-speed shear force dispersion at 6000 rpm for 30 min was performed for homogenization. Upon completion, the homogenate was coated on the surface of the olypropylene spun-laced nonwoven fabric by a blade coating method, then sent to a vacuum drying oven for drying at 80° C. After drying for 6 h, the weight was constant, and a finished product of the graphene material coating with a coating thickness of 50 um was formed. The layer was used as a filtering layer and a supporting layer/a filtration aiding layer, and the pure cotton gauze was used as an outer covering layer. After being subjected to the processes of packaging, cutting, stitching and calendaring, a filtration device based on the graphene coating was obtained. Upon completion, a sample was taken for particulate filtration test and gas filtration test with artificial smoke.

### Embodiment 2

A dispersant of a mixture of sodium polystyrene sulfonate and sodium dodecyl sulfonate and a binder of a mixture of polyethylene glycol and sodium polyacrylate were respectively added to butanone to prepare a dispersion solution with the dispersant at a mass-to-volume ratio of 0.1% and the binder at a mass-to-volume ratio of 5%. After stirring at 30 rpm for 1 h, a homogeneous emulsion was formed and then subjected to a vacuum defoamation. Upon completion, carboxylated graphene was added to the dispersion solution in batches for several times. High-speed shear force dispersion at 3000 rpm for 20 min was performed for homogenization. Upon completion, the homogenate was coated on the surface of the polyterephthalate needle punched/spun-laced nonwoven fabric by a blade coating method, and subjected to a hot air drying at 60° C. After drying for 2 h, a finished product of the graphene material coating with a coating thickness of 3 um was formed. The layer was used as a filtering layer and a supporting layer, and the combination of pure cotton gauze and pure cotton crepe was used as an outer covering layer. After being subjected to the processes of packaging, cutting, stitching and calendaring, a filtration device based on the graphene material coating was obtained. Upon completion, a sample was taken for particulate filtration test and gas filtration test with artificial smoke.

### Embodiment 3

A dispersant of tetramethylammonium hydrogen carbonate and a binder of epoxy resin were respectively added to a mixed solvent of deionized water and ethanol to prepare a dispersion solution with the dispersant at a mass-to-volume ratio of 5% and the binder at a mass-to-volume ratio of 40%. After stirring at 200 rpm for 2 h, a homogeneous emulsion was formed and then subjected to a vacuum defoamation. Upon completion, dodecylated graphene was added to the dispersion solution in batches for several times. High-speed shear force dispersion at 8000 rpm for 120 min was performed for homogenization. Upon completion, the homogenate was coated on the surface of the polypropylene long staple filter cloth by a blade coating method, and sent to a vacuum drying oven for drying at 120° C. After drying for 8 h, the weight was constant, a finished product of the graphene material coating with a coating thickness of 200 um was formed. The layer was used as a filtering layer and a supporting layer, and the pure cotton long staple filter cloth was used as an outer covering layer. After being subjected to the processes of packaging, cutting, stitching and calendaring, a filtration device based on the graphene material coating was obtained. Upon completion, a sample was taken for particulate filtration test and gas filtration test with artificial smoke.

### Embodiment 4

A dispersant of a mixture of cetyl tetramethyl guanidine carbonate and sodium cetyl benzene sulfonate, a binder of a mixture of polyvinyl alcohol and polyethyleneglycol were respectively added to a mixed solvent of ethyl acetate and dimethyl carbonate to prepare a dispersion solution with the dispersant at a mass-to-volume ratio of 3% and the binder at a mass-to-volume ratio of 15%. After stirring at 800 rpm for 1.5 h, a homogeneous emulsion was formed and then subjected to a vacuum defoammation. Upon completion, mercapto graphene was added to the dispersion solution in batches for several times. A homogenization was performed at a speed of 200 rpm for 6 h. Upon completion, the homogenate was coated on the surface of the carrier composed of polypropylene filter paper, glass fiber and cellulose filter paper by a blade coating method, and sent to a vacuum drying oven for drying at 80° C. After drying for 4 h, the weight was constant, and a finished product of the graphene material coating with a coating thickness of 50 um was formed. The layer was used as a filtering layer and a supporting layer, and the combination of pure cotton gauze, pure cotton crepe cloth and pure cotton long staple filter cloth was used as an outer covering layer. After being subjected to the processes of packaging, cutting, stitching and calendaring, a filtration device based on the graphene material coating was obtained. Upon completion, a sample was taken for particulate filtration test and gas filtration test with artificial smoke.

### Embodiment 5

A dispersant of a mixture of sodium dodecyl sulfonate, sodium dodecyl benzenesulfonate and sodium lignosulfonate, and a binder of a mixture of sodium alginate, sodium pectate, sodium antler were respectively added to a mixed solvent of water, ethanol and n-butanol to prepare a dispersion solution with the dispersant at a mass-to-volume ratio of 4% and the binder at a mass-to-volume ratio of 30%. After stirring at 100 rpm for 2 h, a homogeneous emulsion was formed and then subjected to a vacuum defoamation. Upon completion, a mixture of single-layer graphene and multi-layer graphene was added to the dispersion solution in batches for several times. A homogenization was performed at a speed of 200 rpm for 8 h. Upon completion, the homogenate was coated on the surface of the carrier composed of microporous ceramic filter plate, microporous polypropylene filter plate and cellulose acetate tow filter element by a blade coating method, and sent to a vacuum drying oven for drying at 100° C. After drying for 6 h, the weight was constant, and a finished product of the graphene material coating with a coating thickness of 200 um was formed. The layer was used as a filtering layer and a supporting layer, and the combination of polypropylene long staple filter cloth and polypropylene short staple filter cloth was used as an outer covering layer. After being subjected to the processes of packaging, cutting, stitching and calendaring, a filtration device based on the graphene material coating was obtained. Upon completion, a sample was taken for particulate filtration test and gas filtration test with artificial smoke.

### Embodiment 6

A dispersant of sodium dodecyl benzene sulfonate and a binder of dextrin were respectively added to ethylene carbonate to prepare a dispersion solution with the dispersant at a mass-to-volume ratio of 5% and the binder at a mass-to-volume ratio of 40%. After stirring at 200 rpm for 2 h, a homogeneous emulsion was formed and then subjected to a vacuum defoamation. Upon completion, graphene oxide was added to the dispersion solution in batches for several times. High-speed shear force dispersion at 8000 rpm for 60 min was performed for homogenization. Upon completion, the homogenate was coated on the surface of the polypropylene long staple filter cloth by a blade coating method, and sent to a vacuum drying oven for drying at 100° C. After drying for 7 h, the weight was constant, and a finished product of the graphene material coating with a coating thickness of 150 um was formed. The layer was used as a filtering layer and a supporting layer, and the pure cotton long staple filter cloth was used as an outer covering layer. After being subjected to the processes of packaging, cutting, stitching and calendaring, a filtration device based on the graphene material coating was obtained. Upon completion, a sample was taken for particulate filtration test and gas filtration test with artificial smoke.

### Embodiment 7

A dispersant of a mixture of cetyltrimethylammonium bromide, tetramethylammonium hydrogen carbonate and tetraethylammonium hydrogen carbonate, and a binder of a mixture of polyvinyl acetate emulsion, styrene-butadiene rubber emulsion and polyacrylamide-polyacrylic acid emulsion were respectively added to a mixed solvent of N-methylpyrrolidone, methyl ethyl ketone and 2-heptanone to prepare a dispersion solution with the dispersant at a mass-to-volume ratio of 4.6% and the binder at a mass-to-volume ratio of 36%. After stirring at 170 rpm for 1.2 h, a homogeneous emulsion was formed and then subjected to a vacuum defoamation. Upon completion, a mixture of methylated graphene, allylated graphene and trifluoromethylated graphene was added to the dispersion solution in batches for several times. High-speed shear force dispersion at 5500 rpm for 80 min was performed for homogenization. Upon completion, the homogenate was coated on the surface of the carrier composed of polypropylene needle punched/spun-laced nonwoven fabric, polypropylene short staple filter cloth and polypropylene long staple filter cloth by a blade coating method, and sent to a vacuum drying oven for drying at 110° C. After drying for 5 h, the weight was constant, and a finished product of the graphene material coating with a coating thickness of 180 um was formed. The layer was used as a filtering layer and a supporting layer, and the combination of pure cotton gauze, pure cotton crepe cloth and pure cotton long staple filter cloth was used as an outer covering layer. After being subjected to the processes of packaging, cutting, stitching and calendaring, a filtration device based on the graphene material coating was obtained. Upon completion, a sample was taken for particulate filtration test and gas filtration test with artificial smoke.

The air filtration devices with the graphene material coating prepared in embodiments 1-7 were subjected to particulate filtration test and gas filtration test with artificial smoke, and the test results are listed in the following table:

| Detection item | | Removal Rate of Artificial Smoke of the Embodiments | | | | | |
|---|---|---|---|---|---|---|---|
| Type | Content | 1 | 2 | 3 | 4 | 6 | 7 |
| PAHs | Naphthalene | 92.2% | 91.0% | 91.7% | 94.0% | 95.5% | 93.0% |
| | Benzo [a] | 100% | 100% | 100% | 100% | 100% | 100% |
| | pyrene | | | | | | |
| | Benzo [e] | 100% | 100% | 100% | 100% | 100% | 100% |
| | pyrene | | | | | | |
| | Benzo [b] | 100% | 100% | 100% | 100% | 100% | 100% |
| | fluoranthene | | | | | | |
| | Benzo [k] | 100% | 100% | 100% | 100% | 100% | 100% |
| | fluoranthene | | | | | | |
| | Benzo [j] | 100% | 100% | 100% | 100% | 100% | 100% |
| | fluoranthene | | | | | | |
| VOCs | Formaldehyde | 53.5% | 52.9% | 55.3% | 54.7% | 63.9% | 54.0% |
| | Benzene | 93.5% | 92.9% | 94.1% | 92.9% | 94.9% | 93.0% |
| | Xylene | 69.9% | 68.1% | 68.7% | 70.8% | 71.9% | 72.5% |
| | Styrene | 65.6% | 64.1% | 64.3% | 66.7% | 66.5% | 67.3% |
| | Trichloromethane | 58.8% | 57.0% | 59.2% | 60.8% | 60.3% | 61.1% |
| | Diisocyanate | 98.1% | 97.5% | 99.1% | 97.9% | 99.5% | 98.7% |
| Inorganic | Nitrogen | 82.3% | 92.5% | 83.3% | 84.0% | 83.8% | 81.9% |
| Gases | dioxide | | | | | | |
| | Sulfur dioxide | 81.1% | 80.4% | 82.2% | 83.3% | 81.5% | 81.9% |
| | Sulphur | 82.5% | 81.5% | 83.7% | 84.7% | 83.3% | 81.9% |
| | trioxide | | | | | | |
| | Hydrogen | 67.9% | 66.5% | 67.5% | 67.3% | 68.2% | 69.0% |
| | sulfide | | | | | | |
| | Hydrogen | 84.2% | 81.9% | 85.2% | 86.5% | 84.5% | 84.7% |
| | chloride | | | | | | |
| | Ammonia | 83.9% | 93.2% | 84.5% | 83.7% | 85.0% | 84.6% |
| | Ozone | 71.8% | 70.3% | 72.4% | 73.0% | 71.3% | 73.6% |
| | Carbon | 41.0% | 40.2% | 41.9% | 40.5% | 42.4% | 40.8% |
| | monoxide | | | | | | |
| Heavy | Lead | 95.0% | 93.3% | 94.7% | 99.2% | 95.7% | 96.5% |
| Metal | | | | | | | |
| Suspended | PM2.5 | 94.5% | 92.7% | 94.1% | 95.1% | 94.5% | 93.9% |
| Particles | PM10 | 99.8% | 98.5% | 100% | 100% | 100% | 99.6% |

The foregoing are only the preferred embodiments of the present invention. It should be noted that a number of improvements and modifications may be made by those skilled in the art without departing from the principles of the present invention, and these improvements and modifications should also be considered as falling within the scope of the present invention.

What is claimed is:

1. A graphene material coating, wherein
a graphene material of the graphene material coating comprises a graphene and/or a functionalized graphene; and
the functionalized grapheme comprises one or more items selected from the group consisting of aminated graphene, carboxylated graphene, cyanographene, nitrographene, borate-based graphene, phosphate-based graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride and graphene iodide.

2. A preparation method of a graphene material coating, comprising the following steps:
S1), preparing a slurry dispersion stock solution: adding a dispersant and a binder to a solvent, and stirring to form the slurry dispersion stock solution; and
S2), forming the graphene material coating: adding a powder of a graphene material to the slurry dispersion stock solution, after being homogenized by stirring, coating a homogenate on a surface of a carrier, and drying to obtain a finished product of the graphene material coating.

3. The preparation method of claim 2, wherein, in the step S1):
the solvent comprises one or more items selected from the group consisting of water, deionized water, ultrapure water, N-methylpyrrolidone, N,N-dimethylformamide, tetrahydrofuran, ethanol, n-pentane, ethyl acetate, butanone, heptane, benzene, toluene, 4-methyl-2-pentanone, isobutyl acetate, n-butyl acetate, m-xylene, n-butanol, 2-heptanone, n-hexane, ethylene glycol dimethyl ether, petroleum ether, ethylene glycol diethyl ether, chloroform, carbon tetrachloride, dichloromethane, dimethyl carbonate, ethyl methyl carbonate, diethyl carbonate, ethylene carbonate and isopropanol;
the dispersant comprises one or more items selected from the group consisting of sodium polystyrene sulfonate, polystyrene sulfonic acid, polyvinyl pyrrolidone, sodium dodecyl sulfonate, sodium dodecyl benzene sulfonate, polyvinyl alcohol, sodium lignosulfonate, cetyltrimethylammonium bromide, sodium cholate, tetramethylammonium hydrogen carbonate, tetraethylammonium hydrogen carbonate, tetrabutylammonium hydrogen carbonate, dodecyl tetramethyl guanidine carbonate, cetyl tetramethyl guanidine carbonate and sodium cetyl benzene sulfonate;
the binder comprises one or more items selected from the group consisting of polyvinyl alcohol, polyethylene glycol, polyvinyl acetate emulsion, styrene-butadiene rubber emulsion, polyacrylic acid, polyacrylamide-polyacrylic acid emulsion, sodium polyacrylate, polytetrafluoroethylene, polyvinylidene fluoride, sodium alginate, sodium pectate, sodium antler, sodium carboxymethyl cellulose, dextrin, maltodextrin, epoxy resin, alkyd resin, amino resin, phenolic resin, polyurethane and organopolysiloxanes;
a mass-to-volume ratio of the dispersant in the slurry dispersion stock solution is 0.1-5%; and
a mass-to-volume ratio of the binder in the slurry dispersion stock solution is 5-40%.

4. The preparation method of claim 2, wherein, in the step S2):
the graphene material is a graphene and/or a functionalized graphene;
the functionalized grapheme comprises one or more items selected from the group consisting of aminated graphene, carboxylated graphene, cyanographene, nitrographene, borate-based graphene, phosphate-based graphene, hydroxylated graphene, mercapto graphene, methylated graphene, allylated graphene, trifluoromethylated graphene, dodecylated graphene, octadecylated graphene, graphene oxide, graphene fluoride, graphene bromide, graphene chloride and graphene iodide; and
the finished product of the graphene material coating has a coating thickness of 3-200 μm.

5. An air filtration device, comprising a filtering layer coated with the graphene material coating of claim 1.

6. The air filtration device of claim 5, further comprising supporting layers; wherein the supporting layers are located at two sides of the filtering layer.

7. The air filtration device of claim 6, wherein, a constituent material of the supporting layer comprises one or more items selected from the group consisting of polypropylene needle punched/spun-laced nonwoven fabric, polypropylene short staple filter cloth, polypropylene long staple filter cloth, polyterephthalate needle punched/spun-laced nonwoven fabric, polyester long staple filter cloth, polyester short staple filter cloth, pure cotton needle punched/spun-laced nonwoven fabric, pure cotton long staple filter cloth, pure cotton short staple filter cloth, polypropylene filter paper, glass fiber, cellulose filter paper, polypropylene-polyethylene terephthalate composite filter paper, melt-blown polyester nonwoven fabric, melt-blown glass fiber, microporous ceramic filter plate, microporous polypropylene filter plate, cellulose acetate tow filter element, polypropylene tow filter element and cotton filter element.

8. The air filtration device of claim 6, further comprising an outer covering layer; wherein the outer covering layer is located in an outer side of the supporting layer.

9. The air filtration device of claim 8, wherein, a constituent material of the outer covering layer comprises one or more items selected from the group consisting of pure cotton gauze, pure cotton crepe cloth, pure cotton long staple filter cloth, pure cotton short staple filter cloth, polypropylene long staple filter cloth, polypropylene short staple filter cloth, polypropylene frame and polyethylene frame.

10. An air filtration system, comprising the air filtration device of claim 5.

11. The air filtration system of claim 10, wherein, the air filtration device further comprises supporting layers; and the supporting layers are located at two sides of the filtering layer.

12. The air filtration system of claim 11, wherein, a constituent material of the supporting layer comprises one or more items selected from the group consisting of polypropylene needle punched/spun-laced nonwoven fabric, polypropylene short staple filter cloth, polypropylene long staple filter cloth, polyterephthalate needle punched/spun-laced nonwoven fabric, polyester long staple filter cloth, polyester short staple filter cloth, pure cotton needle punched/spun-laced nonwoven fabric, pure cotton long staple filter cloth, pure cotton short staple filter cloth, polypropylene filter paper, glass fiber, cellulose filter paper, polypropylene-polyethylene terephthalate composite filter paper, melt-blown polyester nonwoven fabric, melt-blown glass fiber, microporous ceramic filter plate, microporous polypropylene filter plate, cellulose acetate tow filter element, polypropylene tow filter element and cotton filter element.

13. The air filtration system of claim 11, wherein, the air filtration device further comprises an outer covering layer; and the outer covering layer is located in an outer side of the supporting layer.

14. The air filtration system of claim 13, wherein, a constituent material of the outer covering layer comprises one or more items selected from the group consisting of pure cotton gauze, pure cotton crepe cloth, pure cotton long staple filter cloth, pure cotton short staple filter cloth, polypropylene long staple filter cloth, polypropylene short staple filter cloth, polypropylene frame and polyethylene frame.
